(19) United States
(12) Patent Application Publication
(10) Pub. No.: US 2011/0012350 A1
(43) Pub. Date: Jan. 20, 2011

(54) Fitting with a Security Ring

(75) Inventors: Giovanni Camozzi, Brescia (IT); Gianluca Gnutti, Brescia (IT)

Correspondence Address: SHOEMAKER AND MATTARE, LTD, 10 POST OFFICE ROAD - SUITE 100, SILVER SPRING, MD, 20910, US

(73) Assignee: CAMOZZI S.P.A. SOCIETA' UNIPERSONALE, Brescia (IT)

(21) Appl. No.: 12/920,903

(22) PCT Filed: Mar. 25, 2008
(86) PCT No.: PCT/IT08/00199

§ 371 Date: Sep. 28, 2010

(30) Foreign Application Priority Data
Mar. 5, 2008 (IT) PCT/IT2008/000145

(51) Int. Cl. F16L 17/00

(52) U.S. Cl. 285/348

(57) ABSTRACT

A fitting has an external body and a caliper element, lodged in an axial cavity of the body and able to block the end of a tube inside the cavity. The caliper element can be moved from a rearward position blocking the tube, to a forward position releasing the tube, and includes a flanged rim protruding from an end of the body. A security ring is joined to the end of the body from which the flanged rim protrudes. The ring has an outer portion which extend axially from the end and can resist at least an axial force exerted manually, and an innermost portion which is flexible so that when subjected to an axial force exerted manually, it can move axially and to touch the flanged rim. The inner and outer portions are reciprocally positioned so pressure can be exerted on the innermost portion only with a special tool.

### FIELD OF THE INVENTION

The present invention relates to a fitting for a tube, especially for braking systems.

### BACKGROUND OF THE INVENTION

Fittings for tubes according to the preamble of claim 1 are already known of. Such fittings are known as rapid or super rapid fittings.

In the braking system sector, especially for heavy vehicles, for reasons of safety, tubes which cannot be extracted from a connection except by an authorised person, are required. As a result, such fittings have a component which blocks the tube that, rather than being possible to manoeuvre by hand as in traditional fittings, is a specific element that can only be manoeuvred through use of a specific tool available to authorised staff.

### SUMMARY OF THE INVENTION

The purpose of the present invention is to propose a fitting making it possible to satisfy such requisite of improved security but which, at the same time, uses traditional components.

Such purpose is achieved by a fitting comprising an external body and a caliper element lodged in an axial cavity of said body and able to block the end of the tube inside said cavity. The caliper element can be shifted from a rearward position blocking the tube to a forward position releasing the tube, and comprises a flanged rim on which the axial force used to shift the caliper into said forwarded release position can be exerted. The flanged rim of the caliper is surrounded by an external security ring portion able to resist at least any axial force exerted manually, said external ring portion being positioned in such a way as to allow access to the flanged rim only by means of a special tool.

In accordance with a particularly advantageous embodiment, the external security ring portion terminates in a narrowed protecting portion, axially distant from and aligned with the flanged rim of the caliper element. Such protecting portion is flexibly yielding if subjected to said axial force exerted manually, so as to be able to be shifted axially into contact with said flanged rim. The external and protecting portions are reciprocally positioned so as to make pressure solely on the innermost portion possible only by use of the special tool.

The external security ring portion which surrounds the flanged rim of the caliper element thus prevents access to the latter, except by means of a special tool of such thickness as to engage the flanged rim only, but not the external ring portion. The protecting portion makes it possible to prevent, at the moment of insertion of the tube in fitting, the passage of foreign bodies such as dirt, dust or oil, inside the fitting.

### BRIEF DESCRIPTION OF THE DRAWINGS

Further features and advantages of the fitting according to the present invention will be evident from the description below, made by way of an indicative and non-limiting example of its preferred embodiments, with reference to the attached figures wherein:

FIG. 1 shows an exploded view of a fitting according to the invention, in a first embodiment;

FIG. 2 shows the same exploded view, but in an axial cross-section;

FIG. 3 shows the assembled fitting in partial axial cross-section;

FIG. 4 shows, in cross-section, the fitting with a tube inserted and a manoeuvring tool in an idle position;

FIG. 4a shows an enlarged detail of FIG. 4;

FIG. 5 shows, in cross-section, the fitting with a tube inserted and the manoeuvring tool in an active position releasing the tube;

FIG. 6 shows an exploded view of a fitting according to the invention, in an embodiment variation;

FIG. 7 shows the same exploded view but in axial cross-section;

FIG. 8 shows in partial axial cross-section, the assembled fitting;

FIG. 9 shows, in cross-section, the fitting with a tube inserted and the manoeuvring tool in an idle position; and

FIG. 10 shows, in cross-section, the fitting with a tube inserted and the manoeuvring tool in an active position releasing the tube.

### DETAILED DESCRIPTION OF THE INVENTION

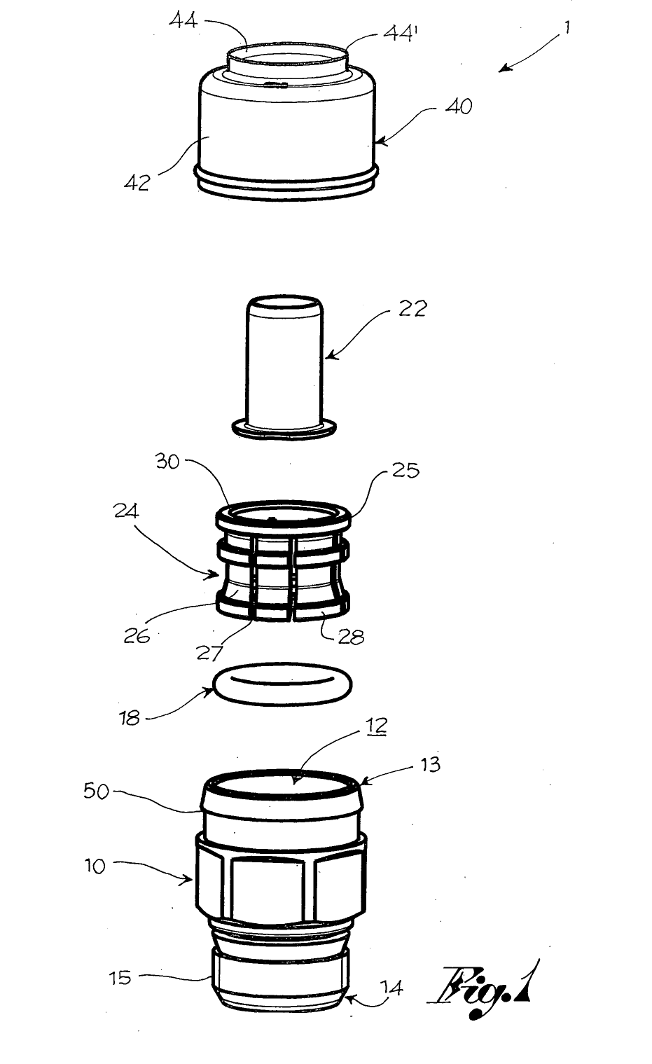

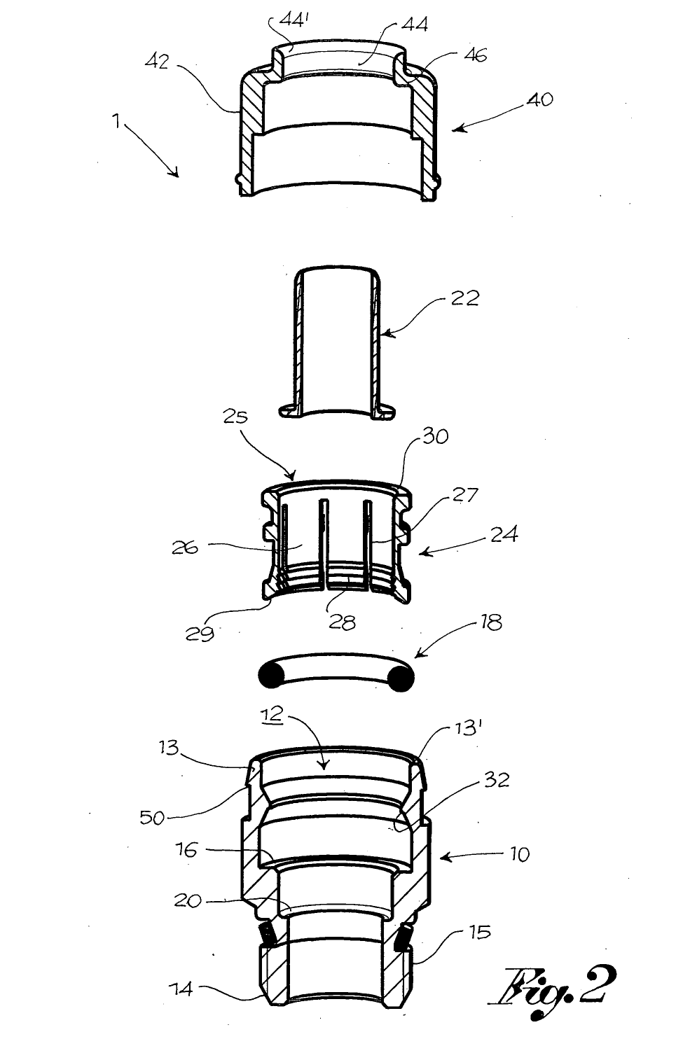

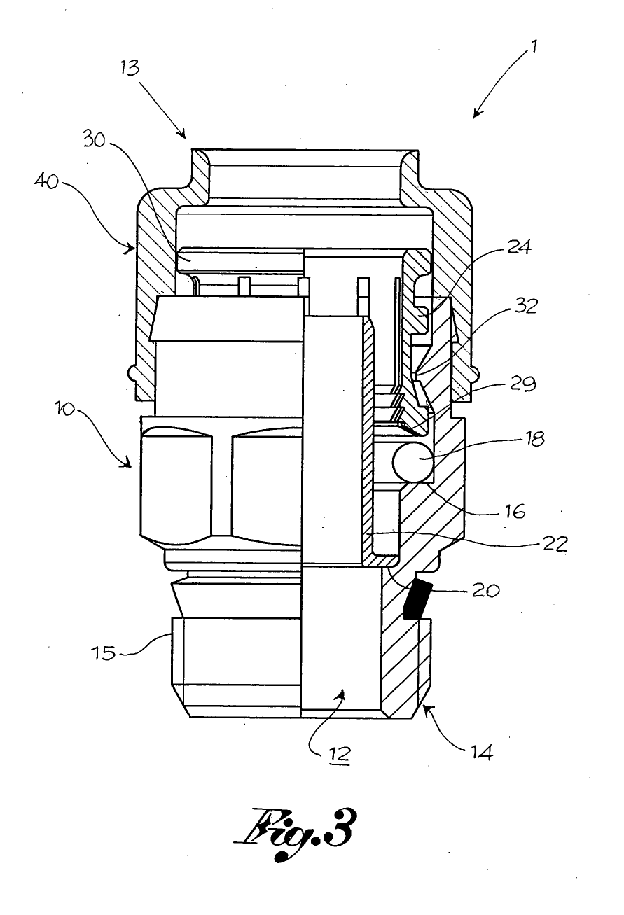

With reference to FIGS. 1-5, reference numeral globally denotes a rapid fitting according to the invention in a first embodiment. The fitting 1 is able to fluidically connect a tube 2 to a fluid collection body—not shown.

The fitting 1 comprises an external body 10 which extends axially from an inlet portion 13, which the tube 2 is inserted into, to an outlet portion 14, suitable for joining to the fluid collector body. To form such coupling, the outlet portion 14 has, for example, a threaded portion 15.

The body 10 defines internally an axial cavity 12.

In the body 10, a first annular shoulder 16 is formed which a sealing element, such as an o-ring 18 rests on.

According to one embodiment, a second annular shoulder 20 is formed inside the body 10 which a guide sleeve 22 for the end of the tube 2 inserted in the fitting 1 rests on, on the opposite side to that on which it is attached to the collector body.

A caliper element 24 is seated in the body 10 for blocking the end of the tube 2 in the fitting 1.

The caliper element 24 is comprises an essentially cylindrical body 25 at the end of which a number of biting teeth 26 are provided, individuated by notches 27 directed according to the generators of the cylindrical body. Each of said teeth 26 has a conical external surface 26′ which tends to widen radially towards the end, and pointed portions 28 facing inwards radially, able to interact with the external surface of the tube 2. Each tooth 26 terminates moreover in a countersunk surface at the end 29 able to interact with the sealing element 18, as will be explained better below.

On the side opposite the teeth 26, the body 25 of the caliper element terminates in a flanged rim 30 which protrudes from the inlet portion 13 of the body 10.

Internally, the body 10 of the fitting 1 also has an annular projection 32 protruding radially inwards and able to interact with the external conical surface 26′ of the teeth 26, when the element is in the blocked position, as will be illustrated below.

Normally, or following the insertion of the end of the tube 2 in the caliper element, the latter finds itself in an idle position, in which the biting teeth 26 are found beyond the annular ridge 32 (in relation to the direction of insertion of the tube) of the body 10. The tube, advancing in the caliper element 24, widens the teeth 26 and hits against the rim of the guide sleeve 22 resting on the second shoulder 20.

Simple pulling of the tube backwards and/or the onset of the pressure of the fluid inside the fitting provokes a backward movement of the tube 2 and therefore an interaction of the pointed portions 28 of the teeth 26 with the surface of the tube. The caliper element 24 too tends therefore to move backwards, until the annular projection ridge 32 in the body 10 engages the external surface 26′ of the teeth 26, pushing them radially and forcing them to bite the tube more strongly. In this position, the tube 2 remains firmly inserted in the fitting.

The fitting 1 also comprises a security ring 40 fitted onto the body 10 of the fitting.

The security ring 40 comprises a cylindrical portion 42 fitted onto the body 10, near the input end 13 and extending axially from such end of the body 10. Said cylindrical portion 42 therefore has a bigger internal diameter than that of the tube 2, for example equal to the external diameter of the flanged rim 30 of the caliper element 24.

The security ring 40 terminates, on the part opposite the body 10, narrowing into an annular protecting portion 44 able to embrace, making contact with the same, the outer surface of the tube 2. In other words, the internal diameter of said annular portion is equal to the external diameter of the tube 2. Consequently, the annular portion 44 is essentially axially aligned to the flanged rim 30 of the caliper element 24.

The cylindrical portion 42 and the annular portion 44 are joined by an intermediate portion 46. Preferably, such intermediate portion 46 extends in a radial direction, that is perpendicularly to the main axis of the fitting 1.

Advantageously, moreover, the annular portion 44 terminates with an inner countersunk surface 44′, so as to facilitate the insertion of the tube 2 into the security ring.

The cylindrical portion 42 of the ring 40 has the characteristic of not being deformable axially if subjected to an axial force exerted with a person's hand. Such function may be obtained by choosing a suitable material and/or appropriate thickness for the cylindrical portion 42.

In addition, advantageously, the resistance to axial deformation of the cylindrical portion 42 is further accentuated by the fact that it rests, at least in part of its transversal cross-section, on the annular rim 13′ defining the inlet of the body 10.

The intermediate portion 46, rather, has the characteristic of being flexibly yielding if subjected to such axial force. In other words, an axial force, exerted that is to say along the main axis of the fitting, applied to the intermediate portion 46 and/or the annular portion 44, causes the bending of such intermediate portion 46 as a result bringing the annular portion 44 closer to the flanged rim 30 of the caliper element 24.

Upon cessation of the axial pressure, the intermediate portion 46 and thus the annular portion 44 connected to it return to their original position.

Such elastic yielding function may be absolved by choosing a suitable material and/or reduced thickness for the intermediate portion 46.

It should be noted that the radial extension of the intermediate portion 46 and of the annular portion 44 is such that once the tube has been inserted in the fitting 1 through the security ring 40, it is not possible to press the intermediate portion and/or annular portion 44 with the fingers without acting on the cylindrical portion 42 too. The result is that the intermediate portion 46 cannot be bent axially and consequently nor can the annular portion 44 be made to advance axially towards the caliper element 24.

By acting rather with a “localised” pressure on the intermediate portion 46 and/or the annular portion 44 only, with the same force applied one can achieve such axial shifting of the annular portion 44.

The length or axial extension of the security ring 40 is chosen so that the axial shift of the annular portion 44 which can be obtained by operating in a manual but localised manner makes it possible to bring said annular portion 44 into contact with the flanged rim 30 of the caliper element, so as to transmit the pressure exerted to the latter.

For the realisation of the security ring 40 advantageously a polymer, natural or synthetic shape memory material may be used at least for the intermediate and annular 44 portions. The different rigidity between the cylindrical portion and the intermediate portion may be obtained by a different cross-linking of the polymer and/or by giving different thicknesses to the two parts, as shown in the example illustrated.

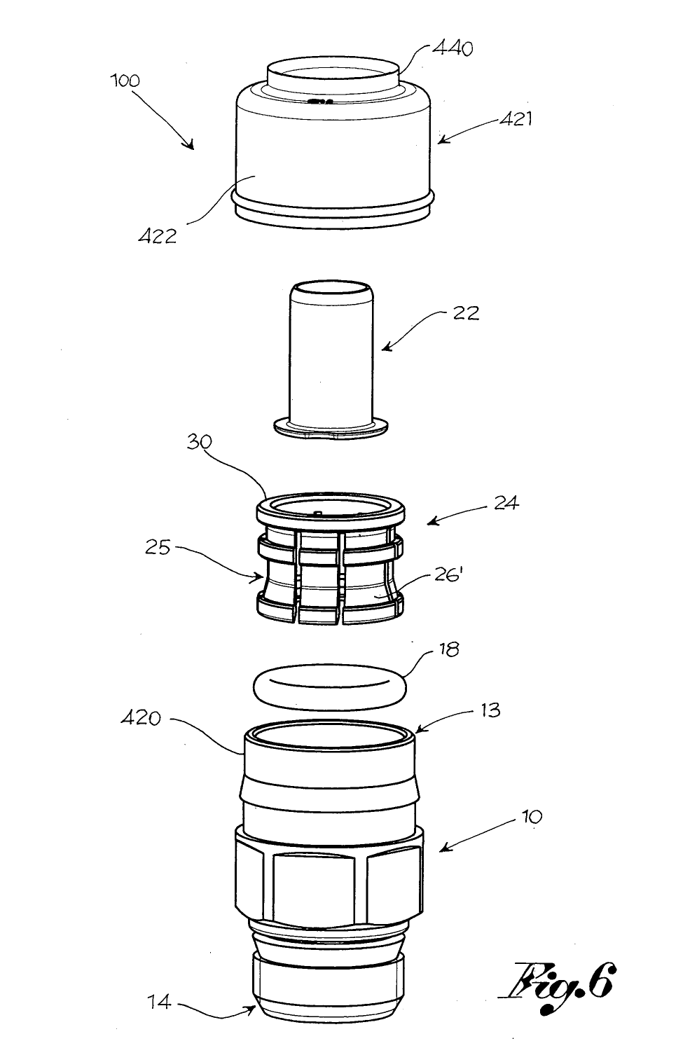

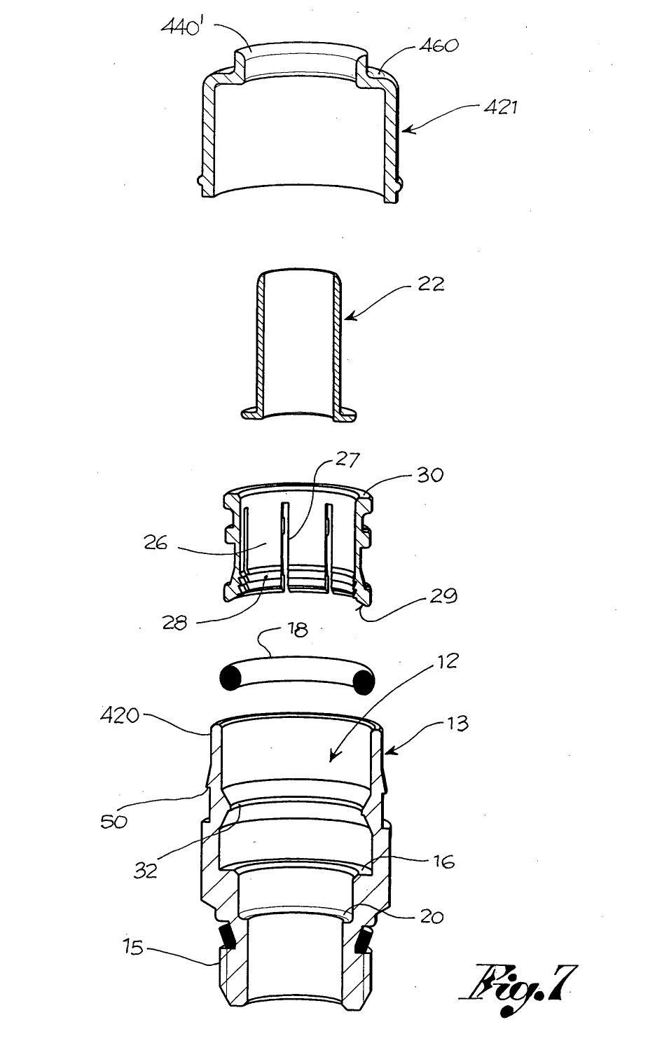

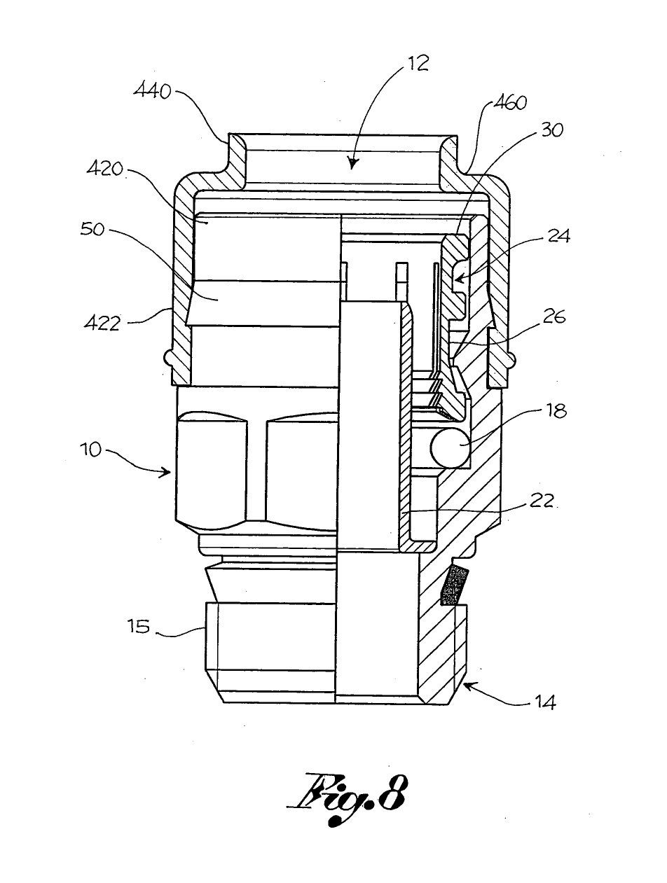

According to an embodiment variation of the fitting 100 illustrated in FIGS. 6-10, wherein the elements of the fitting common to the first embodiment have been indicated with the same reference numerals, the flanged rim 30 of the caliper element 24 is surrounded by an external annular security portion 420 obtained as an extension of the inlet portion 13 of the body 10 of the fitting which terminates at least at the height of the flanged rim 30, preferably beyond said rim, as in the example shown. Once a tube 2 has been inserted in the fitting, such external annular portion 420 prevents access to the flanged rim 30 with the fingers, making the use of tool specially designed for releasing the tube necessary.

Advantageously, at the inlet portion 13 of the body which surrounds the flanged rim 30 of the caliper element a protective cap 421 is fitted which comprises an external cylindrical portion 422, which envelops said inlet portion 13, and which terminates narrowing to an annular portion of protecting 440 axially distanced from and aligned with the flanged rim 30. Such annular protecting portion 440 is able to embrace the outer surface of the tube 2, being in contact with it when inserted in the fitting. Advantageously, moreover, the annular protecting portion 440 terminates with a countersunk inner surface 440′, so as to facilitate insertion of the tube 2.

The annular protecting portion 440 is joined to the external cylindrical portion 422 by an intermediate portion 460. Preferably, such intermediate portion 460 extends in a radial direction, that is, perpendicularly to the main axis of the fitting 100.

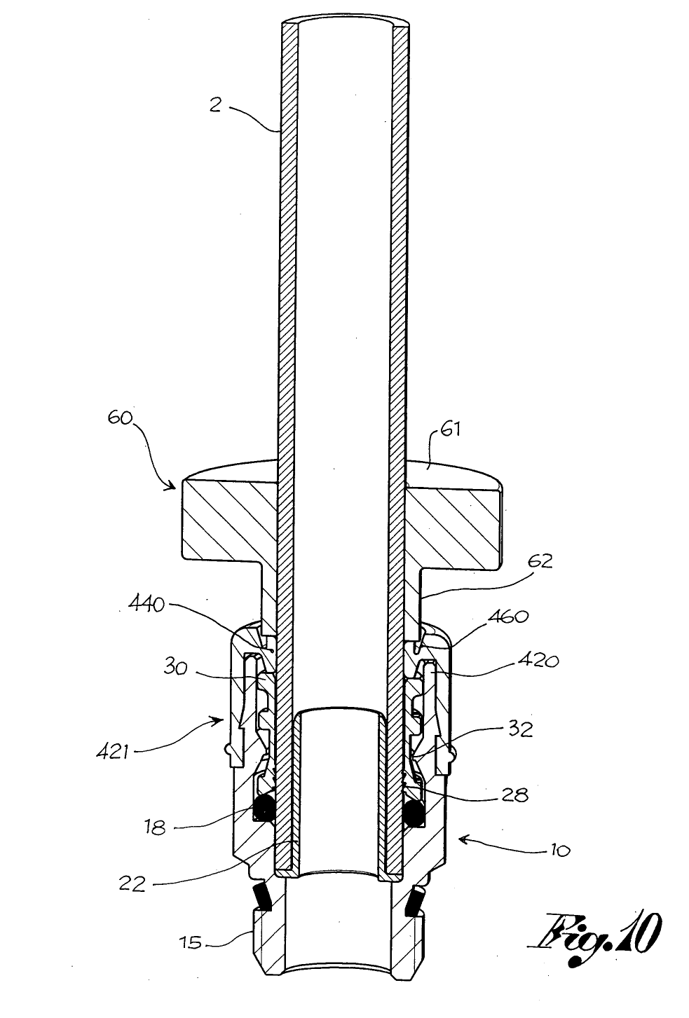

The intermediate portion 460, rather, has the characteristic of being flexibly yielding if subjected to axial force exerted manually. In other words, an axial force, exerted that is to say along the main axis of the fitting, applied to the intermediate portion 460 and/or the annular portion 440, causes the bending of such intermediate portion 460 as a result bringing the annular portion 440 closer to flanged rim 30 of the caliper element 24. (FIG. 10).

Upon cessation of the axial pressure, the intermediate portion 460 and thus the annular portion 440 connected to it return to their original position.

Such elastic yielding function may be absolved by choosing a suitable material and/or reduced thickness for the intermediate portion 460.

In this case too, the radial extension of the intermediate portion 460 and of the annular portion 440 is such that, once the tube 2 has been inserted in the fitting 1, it is not possible to press the intermediate portion 460 and/or the annular portion 440 with the fingers without also acting on the cylindrical extension 420 of the end 13 of the body 10.

In other words, the embodiment variation of the fitting illustrated in FIGS. 6-10 differs from the form of embodiment shown in FIGS. 1-5 by the fact that the cylindrical portion 42 of the security ring 40 is replaced by the extension 420 of the inlet portion 13 of the body 10. In the embodiment variation, therefore, the cylindrical portion 422 of the protective cap 421 has the main function of coupling to the body 10 and acting as a support to the yielding portion 460 and the annular protecting portion 440.

According to one embodiment, near the inlet portion 13, the body 10 is fitted on its outer surface with a cuneiform annular tooth 50 able to facilitate the application of the security ring 40 or protective cap 421 to the body 10 and to prevent accidental slipping off.

The present invention also relates to a tool 60 able to exert localised pressure on the annular protecting portion 44; 440 of the security ring or protective cap respectively.

According to one embodiment, such tool 60 can be rapidly coupled to the tube 2. For example the tool 60 has a “C”-shaped transversal cross-section so as to be geometrically and firmly coupled to the tube 2.

The tool 60 comprises a flanged portion head 61, able to be engaged manually by an operator, and a collar 62 extending from said head portion 61 and which, when the tool 60 is joined to the tube 2, adheres to it and faces the fitting.

The collar 62 is of a thickness more or less equal to that of the annular protecting portion 44; 440, so that however much the tool is pressed into contact with said ring the collar acts solely on the internal annular portion 44; 440, or at most also on the intermediate portion 46; 460.

The tool 60 therefore acts as an adaptor or reducer element to concentrate the force exerted by the operator on the head portion 60 of a circumference, or in any case on an annular surface of a thickness essentially equal to that of the annular portion 44; 440.

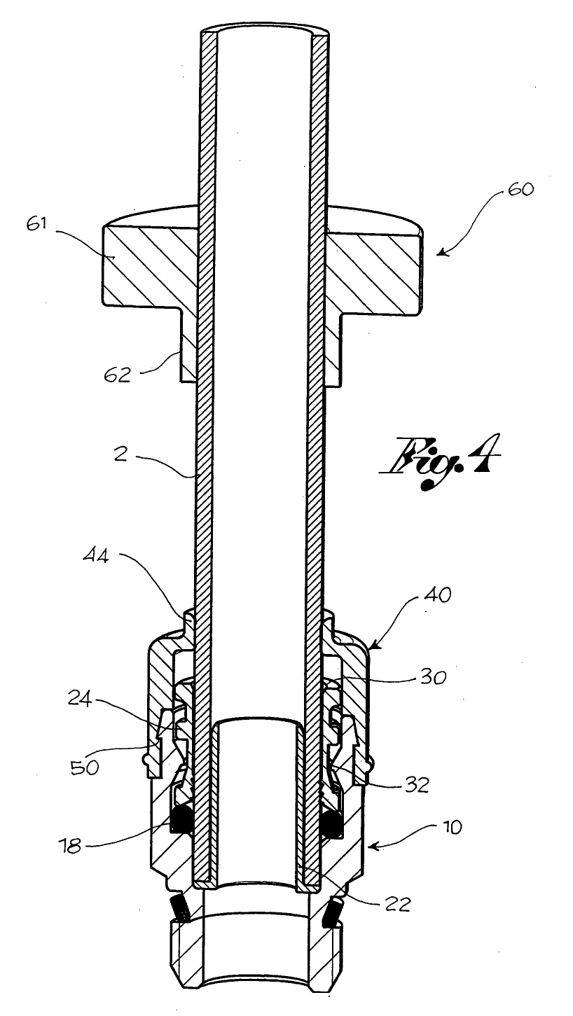

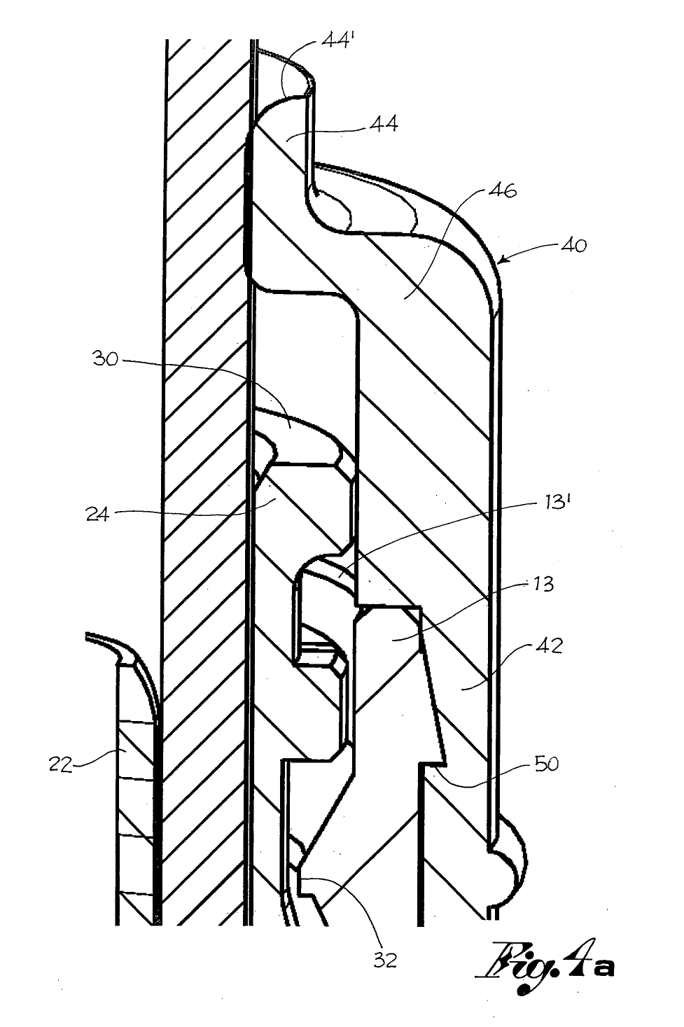

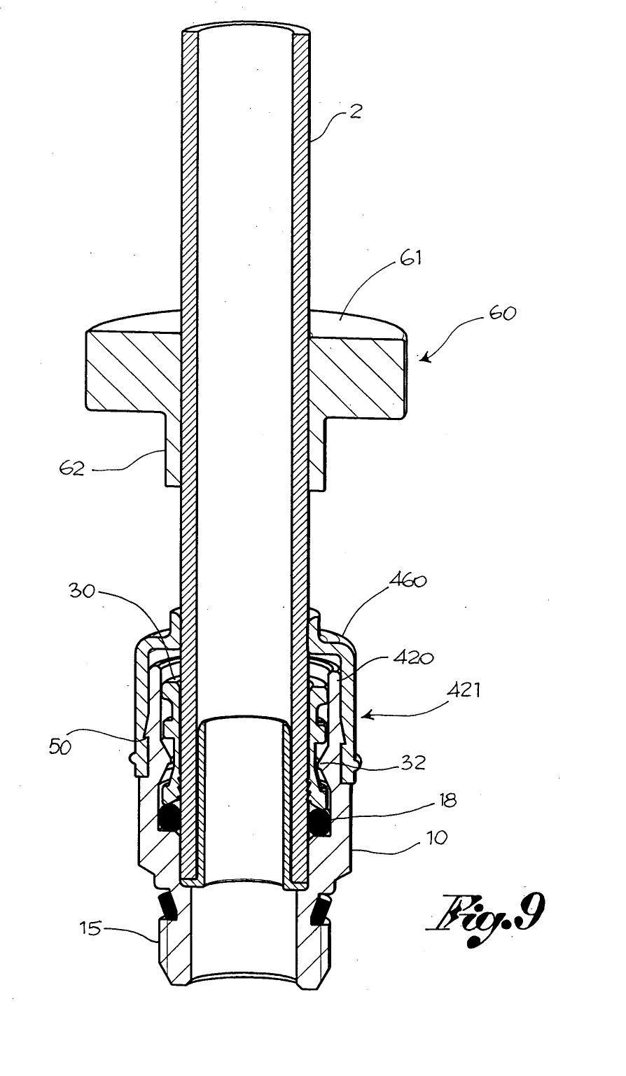

FIGS. 4, 9 show the fitting 1 with the tool 60 connected to the tube 2 but in a distanced position from the annular protecting portion 44; 440.

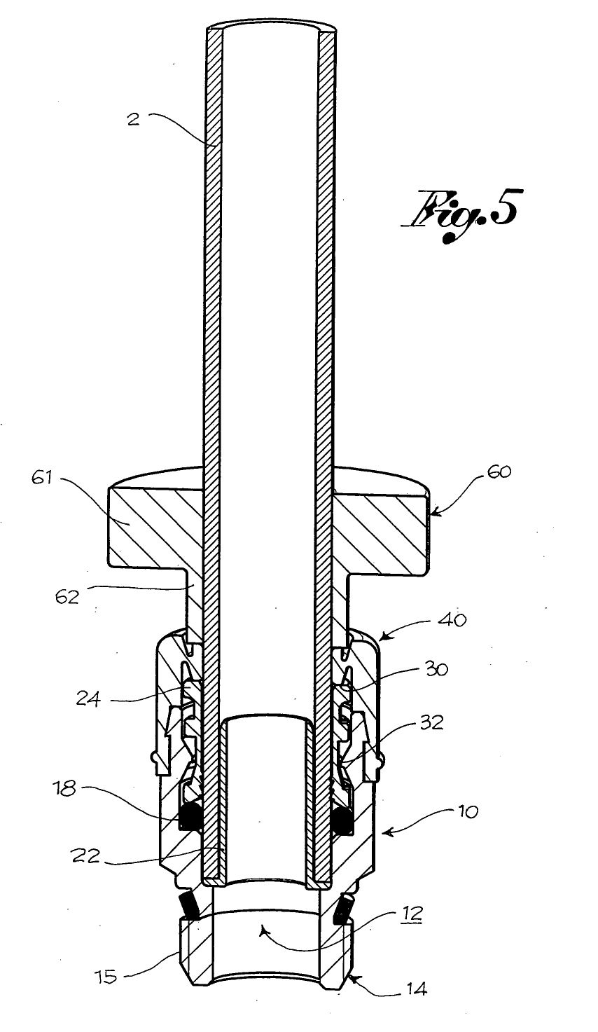

FIGS. 5, 10 show the tool 60 in pressure on the annular portion 44; 440. As anticipated above, in this condition an operator is able, with the tool 60, to act on the annular portion 44; 440 and therefore on the flanged rim 30 of the caliper element 24, pushing it into a forward position in which the tube is released. In such forward position, the biting teeth 26 disengage from the annular ridge 32 and, thanks also to the cone-shaped surface of the end 29 of said teeth and the sealing element 18, distanced sufficiently to enable the disengagement of the pointed portions 28 from the surface of the tube 2, and therefore the extraction of the same from the fitting.

It should be noted that this operation requires a force exerted by the operator similar to the force that direct action on the caliper element of a traditional fitting would require.

Advantageously, the security ring 40 can be fitted onto a fitting 1 having a body 10 and a caliper element 24 of the known type. In other words, this application does not require the supplier of couplings to produce and deal in specific fittings.

A further, non-secondary aspect of the fitting which the present invention relates to is that the annular protecting portions 44, 440 of the security ring 40 and protective cap 421 perform an important function of protecting the fitting from dirt, dust or other agents which might get into it.

In fact, if the tube 2 is not clean, when it is inserted in the security ring 40 or in the protective cap 421 the outer surface of the end which goes into the fitting is cleaned by contact with the annular portion 44; 440 of the security ring or protective cap.

A man skilled in the may make modifications, adjustments and replacements of elements with others functionally equivalent to the fitting described above so as to satisfy contingent requirements, while remaining within the scope of the following claims. Each of the characteristics described as belonging to a possible embodiment may be realised independently of the other embodiments described.

1-16. (canceled)

17. Fitting comprising an external body, axially extending from an inlet portion for the insertion of a tube to an outlet portion, and a caliper element lodged in an axial cavity of said body and able to block the end of a tube inside said cavity, where the caliper element can be moved, with respect to said end of the tube, from a rearward position in which the tube is blocked to a forward position in which the tube is released, and where the caliper element comprises a flanged rim on which axial pressure may be exerted so as to shift the caliper to the advanced release position, wherein said flanged rim is surrounded by an outer security ring portion resting on the inlet portion, or obtained as an extension of the inlet portion, and having such a rigidity to prevent an axial deformation if subjected to an axial force exerted with a person's hand, and wherein said outer security ring portion terminates narrowing into a protecting portion suitable to embrace with contact the outer surface of the tube and axially distanced from, and aligned to, the flanged rim of the caliper element, said protecting portion being flexibly yielding if subjected to an axial force, so as to be able to be brought in contact with said flanged rim, characterised in that said protecting portion has such a radial extension to prevent, once the tube has been inserted in the fitting, to be pressed with the fingers without acting also on the outer security ring portion.

18. Fitting according to claim 17, wherein the radial extension of the protecting portion substantially corresponds to the radial thickness of the flanged rim.

19. Fitting according to claim 17, wherein the flanged rim of the caliper element protrudes from an end of the body, and wherein said outer portions and protecting portions are made in a security ring joined to the end of the body from which said flanged rim protrudes, the outer portion extending axially from said end.

20. Fitting according to claim 19, wherein the outer annular portion of the security ring is a cylindrical portion fitted onto the body of the fitting and having an inner diameter substantially equal to the outer diameter of the flanged rim of the caliper element.

21. Fitting according to claim 17, wherein the protecting portion comprises an annular portion able to embrace the outer surface of the tube when in contact of the same.

22. Fitting according to claim 17, wherein the outer annular portion and the annular protecting portion are joined by an intermediate portion flexibly yielding if subjected to an axial force exerted manually.

23. Fitting according to claim 22, wherein said intermediate portion extends radially, that is, perpendicular to the main axis of the fitting.

24. Fitting according to claim 19, wherein the security ring is made from a natural or synthetic polymer material, with shape memory, and wherein the different rigidity between the cylindrical portion and the intermediate portion is achieved thanks to a different cross-linking of the polymer and/or by using different thicknesses for the two parts.

25. Fitting according to claim 17, wherein the outer security ring portion is obtained from an extension of the body of the fitting which terminates at least at the height of the flanged rim of the caliper element.

26. Fitting according to claim 25, wherein on the end of the body which surrounds the flanged rim of the caliper element a protective cap is fitted which comprises an external cylindrical portion, which envelops said end of the body, and which terminates narrowing to an annular protecting portion axially distanced from and aligned with the flanged rim of the caliper and able to embrace with contact the outer surface of the tube when inserted in the fitting, said annular protecting portion being joined to the outer cylindrical portion by a flexibly yielding intermediate portion, so that it can be shifted axially to come into contact with the flanged rim if subjected to said axial force exercisable manually with a special tool.

27. Fitting according to claim 17, wherein the annular protecting portion terminates with a countersunk inner surface able to facilitate the insertion of the tube in the security ring.

28. Fitting according to claim 17, also comprising a releasing tool suitable for being slidingly coupled to the tube and able to exert localised pressure on the annular protecting portion.

29. Fitting according to claim 28, wherein said tool has a transversal cross-section in the form of a “C” so as to be coupled geometrically and firmly to the tube.

30. Fitting according to claim 28, wherein the release tool comprises a flanged portion head, able to be engaged manually by an operator, and a collar extending from said head portion which, when the tool is joined to the tube, adheres to it and faces the fitting, said collar being of a thickness substantially equal to that of the annular protecting portion.
